(19) United States
(12) Patent Application Publication
(10) Pub. No.: US 2021/0320515 A1
(43) Pub. Date: Oct. 14, 2021

(54) CHARGING DEVICE AND CHARGING METHOD

(71) Applicant: Silergy Semiconductor Technology (Hangzhou) LTD, Hangzhou (CN)

(72) Inventors: Tzuming Yu, Hangzhou (CN); Xiaoqiang Zhu, Hangzhou (CN)

(21) Appl. No.: 17/221,338

(22) Filed: Apr. 2, 2021

(30) Foreign Application Priority Data
Apr. 14, 2020 (CN) 202010289748.3

(51) Int. Cl. H02J 7/00

(52) U.S. Cl. CPC H02J 7/00714; H02J 7/0013

(57) ABSTRACT

A charging method can include: obtaining a charging current for each of a plurality of loads, where each load includes a battery; and adjusting a charging voltage received by each load according to a variation of each charging current, in order to control the charging voltage to vary along with a battery voltage with a highest battery voltage of the plurality of loads in real time.

### RELATED APPLICATIONS

This application claims the benefit of Chinese Patent Application No. 202010289748.3, filed on Apr. 14, 2020, which is incorporated herein by reference in its entirety.

### FIELD OF THE INVENTION

The present invention generally relates to the field of power electronics, and more particularly to charging devices and methods.

### BACKGROUND

A switched-mode power supply (SMPS), or a “switching” power supply, can include a power stage circuit and a control circuit. When there is an input voltage, the control circuit can consider internal parameters and external load changes, and may regulate the on/off times of the switch system in the power stage circuit. Switching power supplies have a wide variety of applications in modern electronics. For example, switching power supplies can be used to drive light-emitting diode (LED) loads.

### BRIEF DESCRIPTION OF THE DRAWINGS

FIG. 1 is a schematic block diagram of an example charging box for wireless earphones.

FIG. 2 is a schematic block diagram of an example charging device, in accordance with embodiments of the present invention.

FIG. 3 is a schematic block diagram of an example control circuit in the charging device, in accordance with embodiments of the present invention.

FIG. 4 is a waveform diagram of a first example operation of the charging device, in accordance with embodiments of the present invention.

FIG. 5 is a waveform diagram of a second example operation of the charging device, in accordance with embodiments of the present invention.

FIG. 6 is a flow diagram of an example charging method, in accordance with embodiments of the present invention.

### DETAILED DESCRIPTION

Reference may now be made in detail to particular embodiments of the invention, examples of which are illustrated in the accompanying drawings. While the invention may be described in conjunction with the preferred embodiments, it may be understood that they are not intended to limit the invention to these embodiments. On the contrary, the invention is intended to cover alternatives, modifications and equivalents that may be included within the spirit and scope of the invention as defined by the appended claims. Furthermore, in the following detailed description of the present invention, numerous specific details are set forth in order to provide a thorough understanding of the present invention. However, it may be readily apparent to one skilled in the art that the present invention may be practiced without these specific details. In other instances, well-known methods, procedures, processes, components, structures, and circuits have not been described in detail so as not to unnecessarily obscure aspects of the present invention.

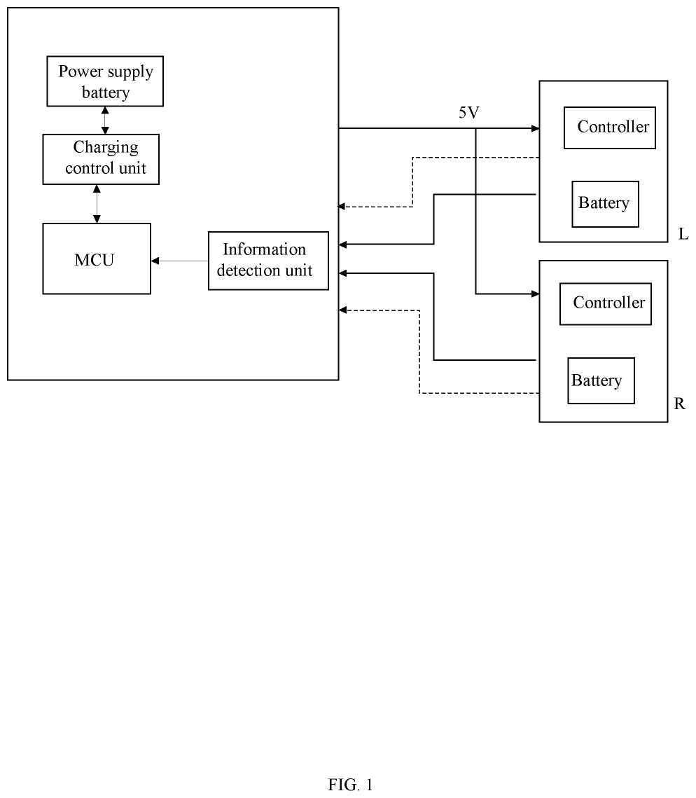

Most electronic devices rely on batteries to provide power for endurance, and the technology for charging the battery has been greatly developed. Referring now to FIG. 1, shown is a schematic block diagram of an example charging box for wireless earphones. Here, A wireless earphone is taken as a load to be charged, for example. The wireless earphones can include left earphone L and right earphone R, and each earphone can include a battery and a controller therein. At present, the wireless earphone can be equipped with a charging device (e.g., the charging box) to be charged, and the charging device generally can include a power supply battery, microcontroller unit (MCU), a charging control unit, and an information detection unit. As used herein, “unit” may indicate circuitry and/or a hardware component. However, a charging voltage generated by the charging device is a constant value (e.g., about 5V), so the charging efficiency may be greatly reduced when the voltage of the battery is low. In addition to positive and negative power lines needed for the connection between the wireless earphones and the charging box, another data transmission interface can also be needed for the wireless earphones to transmit the charging status of the battery in the earphones to the information detection unit of the charging box.

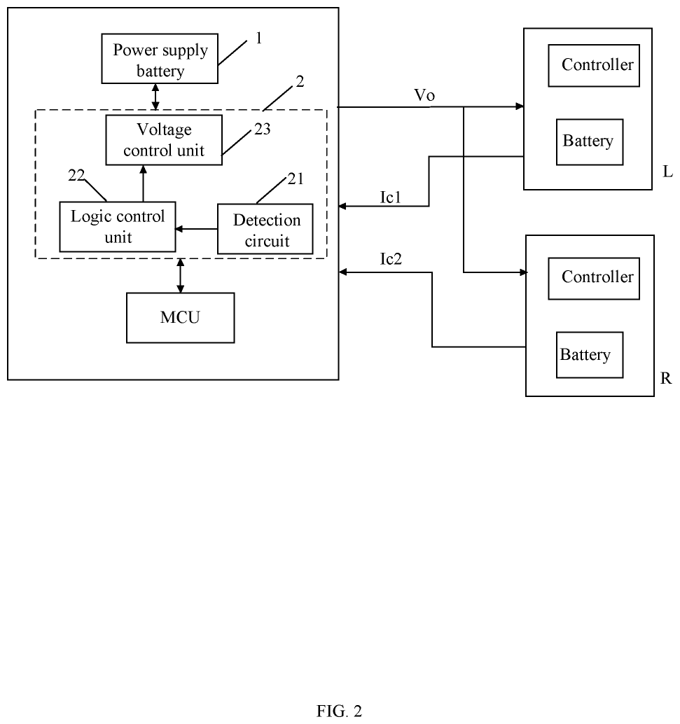

Referring now to FIG. 2, shown is a schematic block diagram of an example charging device, in accordance with embodiments of the present invention. In this example, the charging device can include power supply battery 1, management unit MCU, and control circuit 2. Management unit MCU can generate various control instructions in order to control the circuits in the charging device to make corresponding responses. In this example, management unit MCU can be implemented by any suitable type of management unit MCU. Control circuit 2 can adjust charging voltage Vo generated by the charging device according to the detected variation of a charging current for a load. For example, control circuit 2 can include detection circuit 21, logic control unit 22, and voltage control unit 23. Here, detection circuit 21 can obtain the charging current for the load. Logic control unit 22 can generate different control signals in order to control voltage control unit 23 according to the obtained charging current.

Voltage control unit 23 can convert the voltage of power supply battery 1 to a desired charging voltage Vo. It should be understood that voltage control unit 23 may include boost circuit, buck circuit, buck-boost circuit, low-dropout (LDO), etc., in certain embodiments. For example, earphones are taken as the load to be charged, and each earphone can be connected to the charging device through positive and negative power lines to receive charging voltage Vo generated by the charging device. The earphones can include left earphone L and right earphone R. In this example, left earphone L can include a first controller and a first battery, and charging current Ic1 may flow from the negative power line back to the charging device. Similarly, right earphone R can include a second controller and a second battery, and charging current Ic2 may flow from the negative power line back to the charging device.

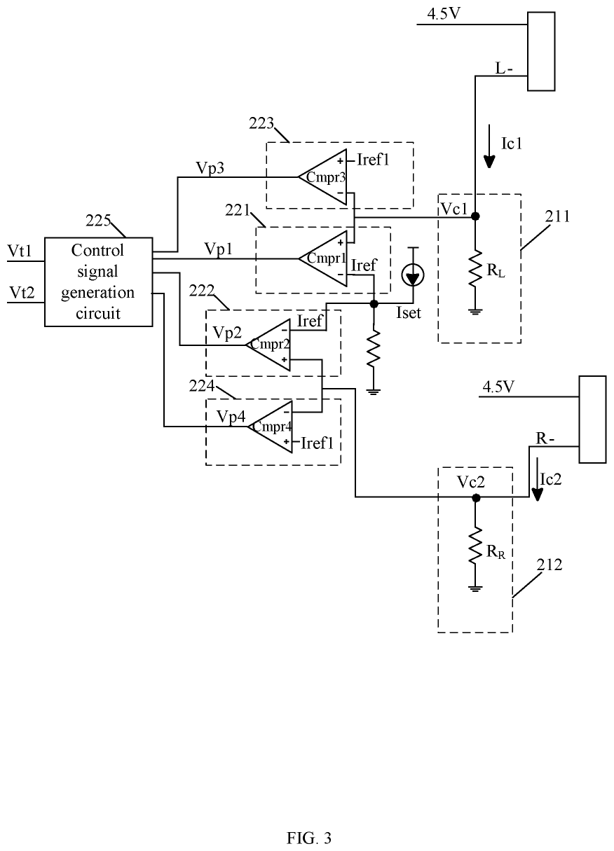

Referring now to FIG. 3, shown is a schematic diagram of an example control circuit in the charging device, in accordance with embodiments of the present invention. In this example, detection circuit 21 can include current generation circuits 211 and 212. Here, current generation circuit 211 can obtain current signal Vc1 representing charging current Ic1 for one earphone (e.g., the left earphone), and may transmit current signal Vc1 to logic control unit 22 of control circuit 2. Similarly, current generation circuit 212 can obtain current signal Vc2 representing charging current Ic2 for another earphone (e.g., the right earphone), and may transmit current signal Vc2 to logic control unit 22 of control circuit 2.

For example, logic control unit 22 can include comparison circuits 221, 222, 223, and 224 and control signal generation circuit 225. Comparison circuit 221 can compare current signal Vc1 against reference signal Iref that represents threshold Iset, in order to generate comparison signal Vp1. When current signal Vc1 is greater than reference signal Iref, that is, when charging current Ic1 is greater than threshold Iset, comparison signal Vp1 can be active, which may indicate that the left earphone has been connected to the charging device. Comparison circuit 222 can compare current signal Vc2 against reference signal Iref, in order to generate comparison signal Vp2. When current signal Vc2 is greater than reference signal Iref, that is, when charging current Ic2 is greater than threshold Iset, comparison signal Vp2 can be active, which may indicate that the right earphone has been connected to the charging device. Therefore, whether the earphone is connected to the charging device can be known by detecting whether the charging current exceeds preset threshold Iset, and thus a dedicated detection circuit for obtaining a signal that the earphone is connected to the charging device can be omitted in certain embodiments.

Comparison circuit 223 can compare current signal Vc1 against adjustment threshold Iref1 that represents threshold Id, in order to generate comparison signal Vp3. When current signal Vc1 is less than adjustment threshold Iref1, that is, when charging current Ic1 is less than threshold Id, comparison signal Vp3 may be active. Comparison circuit 224 can compare current signal Vc2 against adjustment threshold Iref1, in order to generate comparison signal Vp4. When current signal Vc2 is less than adjustment threshold Vref1, that is, when charging current Ic2 is less than threshold Id, comparison signal Vp4 may be active.

In this example, control signal generation circuit 225 can receive comparison signals Vp1, Vp2, Vp3, and Vp4. When comparison signal Vp1 or comparison signal Vp2 is active, control signal generation circuit 225 can activate control signal Vt1 to control voltage control unit 23 to enter a voltage scanning stage. During the voltage scanning stage, charging voltage Vo can be controlled to be decreased step-by-step from initial value Vref, until comparison signal Vp3 or comparison signal Vp4 is active, and then can control signal generation circuit 225 can generate control signal Vt2 to control voltage control unit 23 to stop decreasing charging voltage Vo, and instead charging voltage Vo can be increased by one step.

In addition, logic control unit 22 can determine the state of the battery in the earphone according to the variation of the charging current, and may generate corresponding control signals. After the voltage scanning starts, when the charging current remains unchanged as charging voltage Vo decreases gradually, this can indicate that the voltage of the battery in the earphone has not reached the expected value at this time, and the battery is in a constant current charging mode. When the charging current continues to decrease while the charging voltage is controlled to be increased, this can indicate that the voltage of the battery in the earphone has reached the expected value, and after that, the battery may enter a constant voltage charging mode.

Current generation circuit 211 can include sampling resistor R_{L} for sampling charging current Ic1, which can connect to negative power supply terminal L− of the left earphone connected to the charging device. Current generation circuit 212 can include sampling resistor R_{R} for sampling charging current Ic2, which can connect to negative power supply terminal R− of the right earphone connected to the charging device. For example, comparison circuit 221 can include comparator Cmpr1, and a non-inverting input terminal of comparator Cmpr1 may receive current signal Vc1, an inverting input terminal of comparator Cmpr1 may receive reference signal Iref, and an output terminal of comparator Cmpr1 may generate comparison signal Vp1. Comparison circuit 222 can include comparator Cmpr2, and a non-inverting input terminal of comparator Cmpr2 may receive current signal Vc2, an inverting input terminal of comparator Cmpr2 may receive reference signal Iref, and an output terminal of comparator Cmpr2 may generate comparison signal Vp2.

Comparison circuit 223 can include comparator Cmpr3, and an inverting input terminal of comparator Cmpr3 may receive current signal Vc1, a non-inverting input terminal of comparator Cmpr3 may receive adjustment threshold Iref1, and an output terminal of comparator Cmpr3 may generate comparison signal Vp3. Comparison circuit 224 can include comparator Cmpr4, and an inverting input terminal of comparator Cmpr4 may receive current signal Vc2, a non-inverting input terminal of comparator Cmpr4 may receive adjustment threshold Iref1, and an output terminal of comparator Cmpr4 may generate comparison signal Vp4.

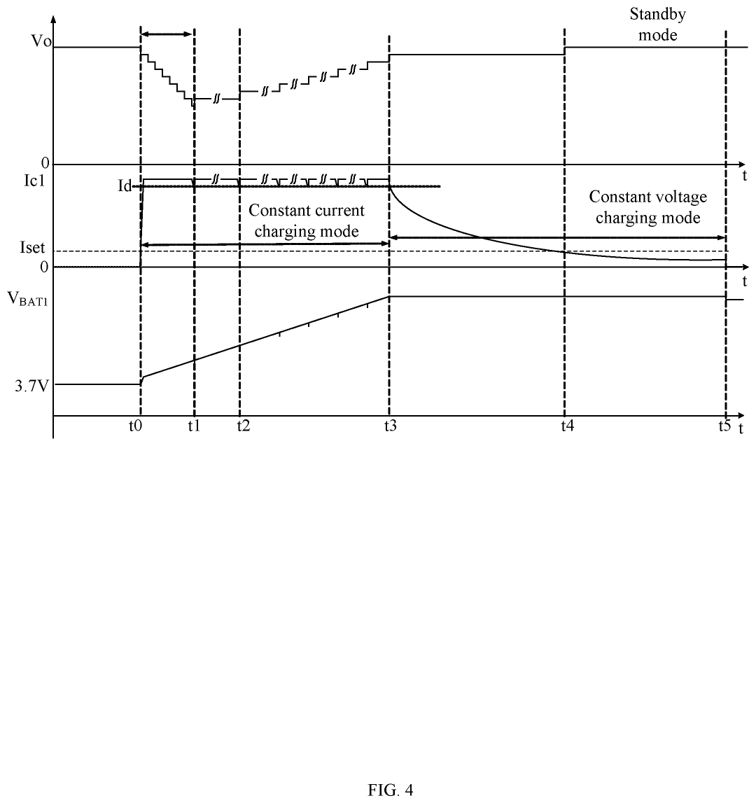

Referring to FIG. 4, shown is a waveform diagram of a first example operation of the charging device, in accordance with embodiments of the present invention. In this example, the left earphone is charged, and we can assume that battery voltage V_{BAT1} of the left earphone before charging is about 3.7V. Before time t0, the left earphone is connected to the charging device. The charging device can charge the left earphone with charging voltage Vo that is initial value Vref (e.g., about 4.5V), and then charging current Id 1 can increase instantaneously. At time t0, charging current Ic1 may exceed threshold Iset (e.g., about 5 mA), such that comparison signal Vp1 is active, and logic control unit 22 can detect that the left earphone has been connected to the charging device for charging, thereby generating control signal Vt1 to voltage control unit 23, in order to control voltage control unit 23 to enter a voltage scanning stage. During the voltage scanning stage, charging voltage Vo can be controlled by voltage control unit 23 to be decreased by a preset step (e.g., about 0.1V) from initial value Vref.

At this time, charging current Ic1 may remain unchanged at a constant current value, which can indicate that the first battery in the left earphone is in a constant current charging mode under the control of the first controller, such that voltage control unit 23 can continue to control charging voltage Vo to be decreased step-by-step with the preset step to performing voltage scanning. Until time t1, charging current Id 1 may drop to threshold Id, so comparison signal Vp3 can become active and the voltage scanning stage ends. Thus, logic control unit 22 may generate control signal Vt2 to voltage control unit 23, such that charging voltage Vo can be controlled by voltage control unit 23 to be increased by one step. Then, charging current Id 1 may rise to the constant current value again. With the adjustment of the above process, charging voltage Vo may be automatically adjusted to follow battery voltage V_{BAT1}, which is equal to V_{BAT1}+Ic1×Rds, where Rds is the on-state resistance of the charging loop in the left earphone.

Under the constant current charging mode, charging current Ic1 may remain at the constant current value, and battery voltage V_{BAT1} of the earphone can gradually increase. With the increase of battery voltage V_{BAT1}, charging voltage Vo is less than V_{BAT1}+Ic1×Rds at time t2, such that charging current Ic1 may begin to drop. When charging current Ic1 drops to threshold Id, charging voltage Vo can be controlled to be increased by one step, such that Vo=V_{BAT1}+Ic1×Rds can be satisfied again. Repeatedly, charging voltage Vo can be controlled to change along with battery voltage V_{BAT1}, thereby improving the charging efficiency.

At time t3, charging current Ic1 may again drop to threshold Id, and then charging voltage Vo can be controlled to be increased by one step. However, logic control unit 22 may detect that charging current Ic1 is still decreasing instead of increasing at this time, which can indicate that battery voltage V_{BAT1} has reached the expected value, and the first battery is under the constant voltage charging mode. Therefore, during time period t3-t4, logic control unit 22 may generate control signal Vt3 to voltage control unit 23 according to the detected state of charging current Ic1, such that charging voltage Vo can be maintained at the expected value and does not continue to change. In addition, charging current Id 1 can continue to drop, and drops to threshold Iset at time t4, which may indicate that the first battery has been fully charged. Thus, logic control unit 22 may generate control signal Vt4 to voltage control unit 23, and charging voltage Vo can be controlled by voltage control unit 23 to be increased to initial value Vref, thereby returning to the standby mode. Thereafter, charging current Ic1 may gradually decrease to zero, and the charging process ends.

It should be understood that the charging process of the left earphone connected to the charging device is described above as an example, and the charging process of the right earphone connected to the charging device is the same. In this example, the charging voltage is adjusted by detecting the variation of the charging current instead of detecting the battery voltage, such that the charging voltage can be automatically adjusted to follow the battery voltage of the earphone; that is, the charging voltage charges the battery at a value close to the real-time battery voltage, thereby improving the charging efficiency and avoiding overheating of the charging device. Moreover, the charging current can be directly obtained from the connecting line between the charging device and the earphone, without adding additional signal lines to transmit any information of the earphone to the charging device.

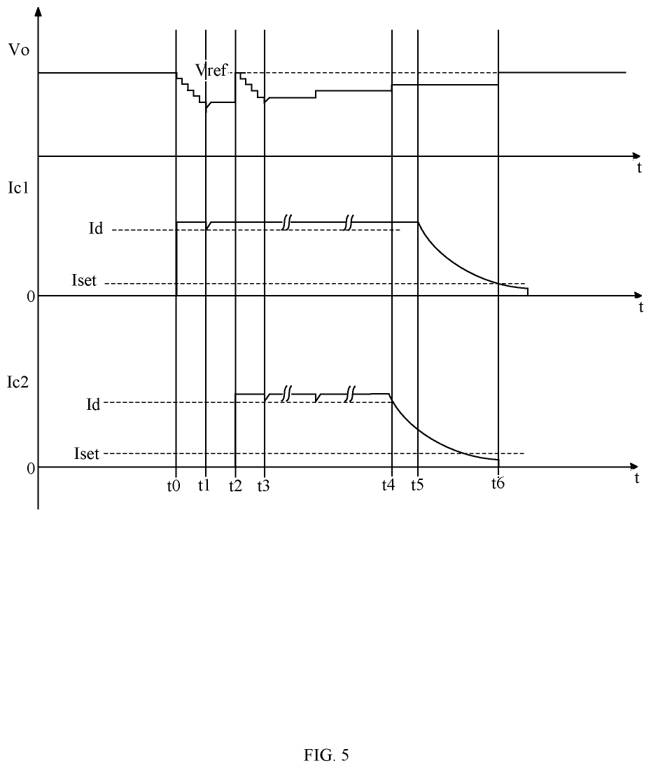

Referring now to FIG. 5, shown is a waveform diagram of a second example operation of the charging device, in accordance with embodiments of the present invention. In this example, the working principle when two earphones are connected to the charging device one after another is illustrated. For example, the left earphone is connected to the charging device before the right earphone, and battery voltage V_{BAT2} of the right earphone is higher than battery voltage V_{BAT1} of the left earphone at the beginning of charging. At time t0, charging current Ic1 of the left earphone may be detected to be greater than threshold Iset, and thus comparison signal Vp1 can become active, which may indicate that the left earphone is connected to the charging device. Therefore, logic control unit 22 may activate control signal Vt1 to voltage control unit 23, in order to control voltage control unit 23 to enter a voltage scanning stage.

During the voltage scanning stage, charging voltage Vo can be controlled to decrease by one step, and if charging current Ic1 is detected to remain unchanged, this can indicate that the first battery in the left earphone is in the constant current charging mode at this time. After that, charging voltage Vo can be controlled to be decreased step-by-step with the preset step. At time t1, charging current Ic1 may decrease to be less than threshold Id, and thus comparison signal Vp3 can be active. Therefore, logic control unit 22 may activate control signal Vt2 to voltage control unit 23, such that charging voltage Vo can be controlled by voltage control unit 23 to be increased by one step. Thus, charging current Ic1 can return to the constant current value.

After that, charging voltage Vo can be maintained at the current value. At time t2, charging current Ic2 can be greater than threshold Iset, and thus comparison signal Vp2 may become active, which may indicate that the right earphone is connected to the charging device. Thus, logic control unit 22 may activate control signal Vt1, such that voltage control unit 23 can control charging voltage Vo back to initial value Vref to perform voltage scanning again. Then, charging voltage Vo can be controlled to be decreased by one step, and if charging current Ic2 is detected to be unchanged, this may indicate that the second battery in the right earphone is also in the constant current charging mode.

After that, charging voltage Vo can be controlled to continue to decrease step-by-step with the preset step. Until time t3, logic control unit 22 may detect that charging current Ic2 drops below threshold Id, and then may activate control signal Vt2, such that voltage control unit 23 can increase charging voltage Vo by one step, and thus charging current Ic2 can rise to the constant current value. Afterwards, charging voltage Vo can be controlled to be maintained at the current value until the decrease of charging current Ic2 is detected again. In this example, since battery voltage V_{BAT2} of the right earphone is greater than battery voltage V_{BAT1} of the left earphone, the final charging voltage Vo may change following the maximum battery voltage (e.g., battery voltage V_{BAT2} of the right earphone). Thus, Vo=V_{BAT2}+Ic2*Rds2.

At time t4, charging current Ic2 drops to threshold Id again, and then charging voltage Vo is controlled to be increased by one step. However, at this time, charging current Ic2 can be detected to be still decreased, which may indicate that the second battery in the right earphone can enter the constant voltage charging mode. Therefore, voltage control unit 23 can control charging voltage Vo to maintain the current value according to control signal Vt3 generated by logic control unit 22. At time t5, it may be detected that charging current Ic1 starts to decrease, and charging voltage Vo may remain unchanged at this time. After time t6, charging currents Ic1 and Ic2 can both be less than threshold Iset, and voltage control unit 23 can control charging voltage Vo to be increased to initial value Vref according to control signal Vt4 generated by logic control unit 22.

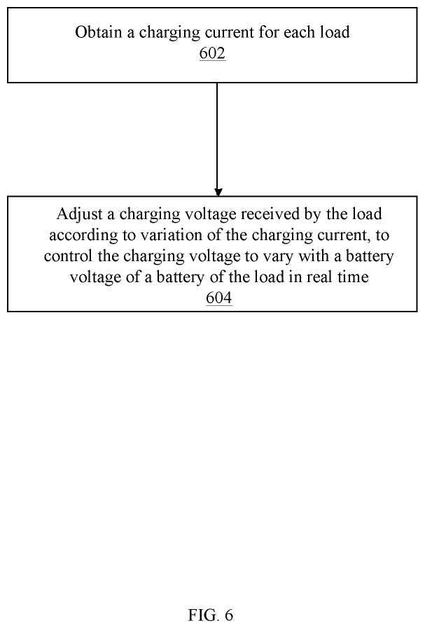

Referring now to FIG. 6, shown is a flow diagram of an example charging method, in accordance with embodiments of the present invention. At 602, a charging current can be obtained for each load. At 604 a charging voltage received by the load can be adjusted according to variation of the charging current, in order to control the charging voltage to vary with a battery voltage of a battery of the load in real time. The charging voltage may approach the sum of the battery voltage of the load and the voltage drop across the charging loop. This example charging method can also include determining whether the load is connected to a charging device according to the charging current. When the charging current for the load is greater than a first threshold, this may indicate that the load is connected to the charging device and a voltage scanning stage operation may begin.

During the voltage scanning stage, the charging voltage can be controlled to be decreased from an initial value, until the charging current for the load decreases. This example charging method can also include comparing the charging current for the load against a second threshold, and controlling the charging voltage to be increased when the charging current for the load drops to the second threshold, such that the charging voltage can follow the current battery voltage of the load. Further, the example charging method also can include controlling the charging voltage to maintain at the current value, when the charging current is detected to decrease while the charging voltage is controlled to increase. Further, the charging method can also include controlling the charging voltage to be equal to the initial value when all the charging current for each load is less than the first threshold, such that the charging device enters a standby mode.

In this way, a charging voltage generated by the charging device may be adjusted according to the variation of a charging current for the load, without detection of the battery voltage separately, such that the charging voltage can be automatically adjusted to follow the battery voltage of the earphones. That is, the charging voltage may approach to the real-time battery voltage, thereby improving the charging efficiency, and avoiding overheating of the charging device. In addition, the charging current can be directly obtained from the connection line between the charging device and the earphone, without the need to add an additional signal line to transmit any information of the earphone to the charging device.

The embodiments were chosen and described in order to best explain the principles of the invention and its practical applications, to thereby enable others skilled in the art to best utilize the invention and various embodiments with modifications as are suited to particular use(s) contemplated. It is intended that the scope of the invention be defined by the claims appended hereto and their equivalents.

What is claimed is:

1. A charging method, comprising:
a) obtaining a charging current for each of a plurality of loads, wherein each load comprises a battery; and
b) adjusting a charging voltage received by each load according to a variation of each charging current, in order to control the charging voltage to vary along with a battery voltage with a highest battery voltage of the plurality of loads in real time.

2. The charging method of claim 1, wherein the charging voltage approaches to a sum of the highest battery voltage and a voltage drop across a charging loop of the load with the highest battery voltage.

3. The charging method of claim 1, further comprising determining whether a corresponding load is connected to a charging device, in accordance with the charging current for the corresponding load.

4. The charging method of claim 3, further comprising indicating that the corresponding load is connected to the charging device when the charging current for the corresponding load is greater than a first threshold.

5. The charging method of claim 3, further comprising controlling the charging voltage to be decreased from an initial value when the corresponding load is connected to the charging device, until the charging current for the corresponding load decreases.

6. The charging method of claim 5, wherein the charging voltage is controlled to be decreased step-by-step with a preset step from the initial value.

7. The charging method of claim 5, further comprising:
a) comparing the charging current for the corresponding load against a second threshold; and
b) controlling the charging voltage to be increased when the charging current for the corresponding load drops to the second threshold, such that the charging voltage follows a current battery voltage of the corresponding load.

8. The charging method of claim 1, further comprising determining an operation mode of the battery in the corresponding load, in accordance with the variation of the charging current for the corresponding load.

9. The charging method of claim 8, further comprising indicating that the battery in the corresponding load is in a constant current charging mode when the charging voltage is controlled to be decreased while the charging current for the corresponding load remains unchanged.

10. The charging method of claim 8, further comprising indicating that the battery in the corresponding load enters a constant voltage charging mode and a current charging voltage is maintained, when the charging current for the corresponding load decreases while the charging voltage is controlled to be increased.

11. The charging method of claim 8, wherein when the plurality of loads is to be charged, the load with the highest battery voltage first enters in a constant voltage charging mode, and the charging current for a second load of the plurality of loads decreases when the charging voltage is unchanged, in order to indicate that the second load enters the constant voltage charging mode.

12. The charging method of claim 1, wherein when each charging current for each load is less than a first threshold, the charging voltage is controlled to be equal to an initial value, such that a charging device enters a standby mode.

13. A control circuit for a charging device, wherein the control circuit is configured to:
a) obtain a charging current for each of a plurality of loads, wherein each load comprises a battery; and
b) adjust a charging voltage generated by the charging device according to a variation of each charging current, in order to control the charging voltage to vary along with a battery voltage with a highest battery voltage of the plurality of loads in real time.

14. The control circuit of claim 13, wherein the charging voltage approaches to a sum of the highest battery voltage and a voltage drop across a charging loop of the load with the highest battery voltage.

15. The control circuit of claim 14, wherein the control circuit further comprises:
a) a detection circuit configured to obtain each charging current for each load;
b) a logic control unit configured to generate different control signals based on each charging current; and
c) a voltage control unit configured to receive the control signals, and to adjust the charging voltage.

16. The control circuit of claim 15, wherein the logic control unit is configured to compare the charging current for a corresponding load against a first threshold, in order to determine whether the corresponding load is connected to the charging device.

17. The control circuit of claim 16, wherein when the charging current for the corresponding load is greater than the first threshold, the corresponding load is indicated as being connected to the charging device.

18. The control circuit of claim 15, wherein the voltage control unit is configured to control the charging voltage to be decreased from an initial value when a corresponding load is connected to the charging device, until the charging current for the load decreases.

19. The control circuit of claim 18, wherein the charging voltage is controlled by the voltage control unit to be decreased step-by-step with a preset step from the initial value.

20. The control circuit of claim 18, wherein the voltage control unit is configured to controlled to control the charging voltage to be increased to make the charging voltage follow a current battery voltage of the corresponding load, when the charging current for the corresponding load is less than a second threshold.
